(19) United States
(12) Patent Application Publication
(10) Pub. No.: US 2018/0315147 A1
(43) Pub. Date: Nov. 1, 2018

(54) MODE OF TRANSPORTATION RECOMMENDATION

(71) Applicant: Intel Corporation, Santa Clara, CA (US)

(72) Inventors: OMRI MENDELS, Tel Aviv (IL); NATHAN TEDGUI, Boulogne-Billancourt (FR); ODED VAINAS, Petah Tiqwa (IL); RONEN SOFFER, Tel Aviv (IL)

(21) Appl. No.: 15/582,154

(22) Filed: Apr. 28, 2017

(51) Int. Cl. G06Q 50/30; G06Q 10/10; G06Q 50/26

(52) U.S. Cl. CPC G06Q 50/30; G06Q 50/26; G06Q 10/1095

(57) ABSTRACT

Apparatuses, systems and methods associated with mode of transportation recommendation are disclosed herein. In embodiments, a device may include communication circuitry to communicate with a server and a user interface to interact with a user of the device. The device may further include an analyzer to identify a future trip to be travelled by the user, and identify a destination associated with the future trip. The device may further include a recommendation engine to transmit, to the server, a recommendation trigger message that includes an indication of the destination; receive, from the server, an indication of a mode of transportation to the destination, the indication of the mode of transportation based on prior trip information of the user; and cause a notification for use of the mode of transportation to the destination to be indicated by the user interface. Other embodiments may be described and/or claimed.

### TECHNICAL FIELD

The present disclosure relates to the field of predictive systems. More particularly, the present disclosure relates to a mode of transportation recommendation.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Individuals may develop habits and preferences when travelling between locations. An individual may prefer a certain mode of transportation depending on certain characteristics (such as destination, weather, or other characteristics) and/or may prefer a different mode of transportation depending on different characteristics.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example mode of transportation recommendation system, according to various embodiments.

FIG. 2 illustrates an example identified prior trip entry, according to various embodiments.

FIG. 3 illustrates an example relationship between a classification and prior trips, according to various embodiments.

FIG. 4 illustrates an example classification, according to various embodiments.

FIG. 5 illustrates an example procedure for generation of a recommendation trigger message, according to various embodiments.

FIG. 6 illustrates an example procedure for identification of a mode of transportation for a future trip, according to various embodiments.

FIG. 7 illustrates an example procedure for initiation of a notification of the mode of transportation for the future trip, according to various embodiments.

FIG. 8 illustrates an example procedure for recording user state information, according to various embodiments.

FIG. 9 illustrates an example procedure for associating a mode of transportation with a classification, according to various embodiments.

FIG. 10 illustrates an example computing device that may employ the apparatuses and/or methods described herein.

### DETAILED DESCRIPTION

Apparatuses, systems and methods associated with mode of transportation recommendation are disclosed herein. In embodiments, a device may include communication circuitry to communicate with a server and a user interface to interact with a user of the device. The device may further include an analyzer to identify a future trip to be travelled by the user, and identify a destination associated with the future trip. The device may further include a recommendation engine to transmit, to the server, a recommendation trigger message that includes an indication of the destination; receive, from the server, an indication of a mode of transportation to the destination, wherein the indication of the mode of transportation may be based on prior trip information of the user; and cause a notification for use of the mode of transportation to the destination to be indicated by the user interface.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit including a programmable circuit, such as but not limited to field programmable gate arrays (FPGA), a processor (shared, dedicated, or group) and/or memory (shared, dedicated, or group) that execute one or more software or firmware programs, a combinational logic circuit, and/or other suitable components that provide the described functionality.

As used herein, the term “communicatively coupled” may refer to coupling of elements via communication methods associated with electronic devices. “Communicatively coupled” may refer to coupling of the elements via wired and/or wireless communication. Elements that are “communicatively coupled” may be coupled via Ethernet communication, hard-wired communication, wireless-fidelity communication, Bluetooth communication, infrared communication, satellite communication, radio communication, near field communication, mobile communication, wireless metropolitan area network communication, wireless wide area network communication, or some combination thereof.

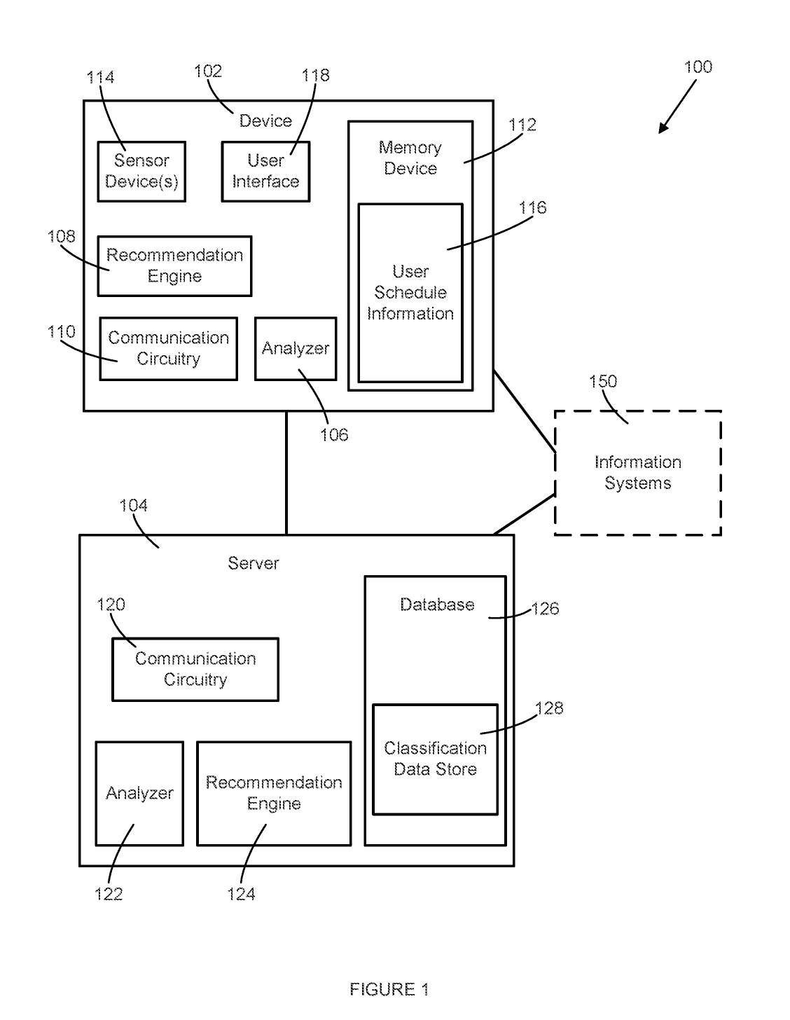

FIG. 1 illustrates an example recommendation system 100, according to various embodiments. The recommendation system 100 may include a device 102 and a server 104. The device 102 and the server 104 may be communicatively coupled with each other. The device 102 may be located remote to the server 104, and communicatively coupled with each other via one or more wired and/or wireless networks.

The device 102 may include communication circuitry 110, which may be used to communicate with communication circuitry 120 of the server 104. In some embodiments, the recommendation system 100 may further include and/or be communicatively coupled to information systems 150. The information systems 150 may include locator systems (such as global positioning systems (GPS), wireless-fidelity systems that may be used for determining location, cellular systems that may be used for determining location, or some combination thereof), public transportation systems, weather systems, traffic report systems, emergency systems, or some combination thereof. The information systems 150 may be communicatively coupled to the device 102 and/or the server 104, via one or more wired and/or wireless networks. In some embodiments, the recommendation system 100 may not be communication coupled to the information systems 150 and the information systems 150 may not be included in the recommendation system 100.

The device 102 may include a travel device, such as mobile device, a smart phone, a wearable electronic system (wearable smart glasses and/or smart headphones), a laptop, a tablet, a user equipment, or some combination thereof. The device 102 may include a memory device 112 to store data of the device 102. The device 102 may be associated with a particular user, either via registration of the user as an owner of the device 102, the user being signed into an operating system of the device 102, similar means of indicating that the device 102 is associated with the user, or some combination thereof.

The device 102 may further include a user interface 118 to interact with a user of the device. The user interface 118 may include a user input device (such as a mouse, a keyboard, a touchscreen, a microphone, other similar user input devices, or some combination thereof), a display device (such as a monitor, a touchscreen, a display, or some combination thereof), an audio output device (such as speakers, headphones, or some combination thereof), or some combination thereof. The user interface 118 may receive input from the user of the device and/or output information to the user (such as displaying a visual depiction and/or message on the user interface, playing an audio recording, playing a sound, causing a physical interaction with the user via device 102, or some combination thereof).

The device 102 may further include one or more sensor devices 114 that may sense information associated with the device 102 and/or an environment proximate to the device 102. The sensor devices 114 may include an accelerometer, a gyroscope, other motion sensors, a microphone, other sound sensors, a camera, other visual sensors, or some combination thereof. The sensor device 114 may store sensed data on the memory device 112 to be accessed by other elements of the device 112.

The device 102 may include an analyzer 106. The analyzer 106 may include, and/or may be implemented by, circuitry, an application-specific integrated circuit (ASIC), field-programmable gate array (FPGA), software, or some combination thereof. The analyzer 106 may analyze stored data on the device 102 to identify a future trip to be travelled by a user of the device 102. Further, the analyzer 106 may be able to identify a destination, a starting location, an arrival time, or some combination thereof, for the future trip based on the analysis of the stored data.

The analyzer 106 may be able to access data stored on the device 102 associated with future appointments of the user and may identify appointments based on the data. The device 102 may include applications and/or software, such as a calendar application, that may store user appointment information 116 on the memory 112. The user appointment information 116 may include a date of the appointment, a time of the appointment, a location of the appointment, other specifics associated with the appointment, or some combination thereof. The analyzer 106 may access the user appointment information 116, either via the applications/software or directly, and extract the specifics of the appointment, including the date of the appointment, a time of the appointment, a location of the appointment, or some combination thereof.

In some embodiments, the analyzer 106 may detect an input to the user interface 118 from the user for a future appointment. The input may include a starting location, a destination, a time, an intent for the future appointment, or some combination thereof. For example, the user may input “I need to pick up the kids from school at 1 pm.” The analyzer 106 may identify the appointment based on the input and may extract the specifics of the appointment from the input.

Further, in some embodiments, the analyzer 106 may identify visitation routines and/or mobility patterns of the user and identify a future appointment based on the visitation routines and/or mobility patterns of the user. For example, the visitation routines and/or mobility patterns may include that the user usually visits a certain location at a certain time, that the user usually visits two or more locations in sequence, or some combination thereof. The analyzer 106 may identify the visitation routines and/or mobility device 112 based on user state information stored in the memory device 112 of the device 102 (as described further throughout this disclosure).

In some of these embodiments, the analyzer 106 may request and/or receive indications of visitation routines and/or mobility patterns from the server 104 via the communication circuitry 110. An analyzer 122 of the server 104 may identify visitation routines and/or mobility patterns of the user from user state information and/or classifications associated with the user stored within a database 126 of the server 104. The analyzer 122 of the server 104 may transmit, via a communication circuitry 120 of the server 104, the indication of the visitation routines and/or mobility patterns in response to identifying the visitation routines and/or mobility patterns, receiving a request from the device 102 for visitation routines and/or mobility patterns of the user, or some combination thereof. The analyzer 106 may store the indications received from the server 104 and/or information from the indications on the memory device 112 and may utilize the stored indications and/or information to identify future trips.

The device 102 may further include a recommendation engine 108. The recommendation engine 108 may include, and or be implemented by, circuitry, an application-specific integrated circuit (ASIC), field-programmable gate array (FPGA), software, or some combination thereof. The recommendation engine 108 may be communicatively coupled with the analyzer 106 and may operate in combination with the analyzer 106 to provide the user with a mode of transportation recommendation. In some embodiments, the recommendation engine 108 may receive input from other elements of the device 102, and may operate independently from the analyzer 106, or independently from the analyzer 106 in certain circumstances and with the analyzer 106 in other circumstances, to provide the user with the mode of transportation recommendation.

The recommendation engine 108 may receive the extracted specifics of the appointment from the analyzer 106. The recommendation engine 108 may determine information from the extracted specifics that is to be used for determining a mode of transportation. The recommendation engine 108 may determine a destination for the appointment based on the location of the appointment, an arrival time at the destination based on the time of the appointment, a starting location for the future trip based on a temporally adjacent appointment, or some combination thereof. The ending time of the temporally adjacent appointment may be within a certain time period of the starting time of the appointment associated with the future trip for determining the starting location, such as within 15 minutes, 30 minutes, 45 minutes, or an hour.

In some embodiments, the recommendation engine 108 may further communicate with the information systems 150 via the communication circuitry 110. The recommendation engine 108 may retrieve a current location of the device 102 from the information systems 150, such as retrieving the current location of the device 102 from the GPS. The recommendation engine 108 may supplement the information from the extracted specifics with the current location of the device 102. Further, the recommendation engine 108 may determine that the current location of the device 102 is the starting location for the future trip based on the arrival time at the destination and the current time. In particular, the recommendation engine 108 may determine that the current location of the device 102 is the starting location in response to determining that a difference between the arrival time and the current time is less than a specified time period, such as 15 minutes, 30 minutes, 45 minutes, or an hour. In some embodiments, the recommendation engine 108 may forgo determining the starting location for the future trip and the server 104 may determine the starting location, as described further throughout this disclosure.

Further, in some embodiments, the recommendation engine 108 may receive preferences of the user for the future trip via the user interface 118 and/or via stored user preferences for future trips on the memory device 112. The preferences may include time efficiency for the future trip, cost efficiency for the future trip, a preference for walking, running, bicycling or other user-based modes of transportation, or some combination thereof. Further, the preferences may be dependent on other characteristics, such as the user prefers to walk for trips less than three miles, but prefers to drive for trips greater than three miles.

The recommendation engine 108 may generate a recommendation trigger message based on identifying the future trip. The recommendation trigger message may include the information for determining the mode of transportation, including a destination for the appointment based on the location of the appointment, an arrival time at the destination based on the time of the appointment, a starting location for the future trip based on a temporally adjacent appointment, the preferences of the user, or some combination thereof. The recommendation engine 108 may transmit the recommendation trigger message to the server 104 via the communication circuitry 110.

The server 104 may receive the recommendation trigger message via the communication circuitry 120. The server 104 may include an analyzer 122 that may analyze the information included in the recommendation trigger message. The server 104 may further include a recommendation engine 124 for generating an indication of a mode of transportation for the future trip and a database 126 that may store information associated with prior trips of the user. In some embodiments, the database 126 may not be included in the server 104, but the server 104 may be communicatively coupled to another system (such as a cloud system) that includes the database 126. The database 126 may be a graph database, a relational database, or some combination thereof.

The analyzer 122 may determine a destination of the future trip, a starting location for the future trip, an arrival time at the destination, preferences of the user, or some combination thereof, based on the information included in the recommendation trigger message. In some embodiments, the recommendation trigger message may include an indication of a current location of the device 102 and the analyzer 122 may determine that the starting location for the future trip is to be the current location. In particular, the analyzer 122 may determine that the current location of the device 102 is to be the starting location based on an arrival time at the destination being within a certain time period of the current time. In some embodiments, the certain time period may be 15 minutes, 30 minutes, 45 minutes, or an hour.

The analyzer 122 may further determine at least one characteristic associated with the future trip based on the starting location and the destination. The at least one characteristic may include the information from the recommendation trigger message, information derived from the starting location and the destination (such as a length of the future trip), or some combination thereof. In some embodiments, the characteristics may be determined based on other information included recommendation trigger message, and may include a time of day that the future trip is scheduled to occur, a day of the week the future trip is scheduled to occur, a date the future trip is scheduled to occur, or some combination thereof.

In some embodiments, the analyzer 122 may forgo determination of the destination and/or the location of the future trip. In these embodiments, the analyzer 122 may determine the at least one characteristic based on other information included in the recommendation trigger message. For example, the recommendation trigger message may include an arrival time and the analyzer 122 may determine a time of day, a day of the week, a date, or some combination thereof based on the arrival. The analyzer 122 may determine the at least one characteristic to be, or to be based on, the time of day, the day of the week, the date, or some combination thereof.

In some embodiments, the analyzer 122 may obtain information from the information systems 150 via the communication circuitry 120 based on the information included in the recommendation trigger message. In embodiments where the recommendation trigger message does not include a starting location or a current location of the device 102, the analyzer 122 may obtain a current location of the device 102 from the information systems 150, such as via the GPS of the information systems 150 and/or other locator systems included in the information systems 150. The characteristics associated with the future trip, as determined by the analyzer 122, may include the starting location.

The analyzer 122 may further obtain weather information for the future trip from the information systems 150. The analyzer 122 may query a weather report service of the information systems 150 for one or more weather reports associated with the starting location of the future trip, the destination of the future trip, a possible route between the starting location and the destination (which may be obtained from software and/or a website that provides directions of the information systems 150), or some combination thereof. The analyzer 122 may derive the weather information for the future trip from the one or more weather reports associated with the future trip. The characteristics associated with the future trip, as determined by the analyzer 122, may include the weather information.

The analyzer 122 may further obtain public transportation information for the future trip from the information systems 150. The analyzer 122 may query public transportation information systems (such as public transportation websites for buses, trains, subways, light rails, or other public transportation) for public transportation information associated with the future trip. The public transportation information may include a route of public transportation to travel from the starting location to the destination of the future trip, a mode of transportation (bus, train, subway, light rail, or other modes of public transportation) associated with the route or routes, a walking distance associated with the route or routes, a wait time associated with the route or routes, a number of transfers (such as transfers between buses, trains, subways, light rails, or some combination thereof) associated with the route or routes, a travel time associated with the route or routes, or some combination thereof. The analyzer 122 may determine a convenience associated with the public transportation based on the public transportation information. For example, the convenience may include a convenience score calculated based on the public transportation information. The characteristics associated with the future trip, as determined by the analyzer 122, may include the convenience associated with the public transportation.

The recommendation engine 124 may receive the characteristics associated with the future trip from the analyzer 122. Based on the characteristics associated with the future trip, the recommendation engine 124 may identify a classification associated with the future trip. The database 126 may include one or more classifications associated prior trips travelled by the user. Each of the classifications may include one or more characteristics common to prior trips used for generating the classification. The recommendation engine 124 may compare the characteristics associated with the future trip to the characteristics associated with each of the classifications within the classification data store 128 to identify a classification for the future trip based on the classification, of the classification data store 128, with the same, or most similar, characteristics as the characteristics of the future trip.

Each of the classifications within the classification data store 128 may further be associated with a mode of transportation based on the mode of transportation utilized in the prior trips, or the mode of transportation with the greatest frequency of use, included in each of the classifications. The recommendation engine 124 may identify a mode of transportation for the future trip based on the classification of the future trip. In particular, the recommendation engine 124 may identify the mode of transportation associated with the classification, of the classification data store 128, with the same, or most similar, characteristics as the characteristics of the future trip and utilize the identified mode of transportation as the mode of transportation for the future trip. The recommendation engine 124 may transmit an indication of the mode of transportation to the device 102 via the communication circuitry 120.

In some embodiments, the analyzer 122 may determine a time difference between the current time and an arrival time at the destination of the future trip in response to the recommendation engine 124 identifying the mode of transportation. The analyzer 122 may further determine a travel time for the mode of transportation from the starting location to the destination. The analyzer 122 may determine the travel time based on travel times from prior trips from the starting location to the destination. In some embodiments, the analyzer 122 may determine the travel time based on travel time information associated with the mode of transportation obtained from the information systems 150 (such as travel time information obtained from software and/or a website that provides directions of the information systems 150.

The analyzer 122 may further compare the time difference between the current time and the arrival time, and the travel time associated with the mode of transportation to determine whether the device will arrive at the destination by the arrival time utilizing the mode of transportation. In response to determining that the travel time is greater than the time difference (i.e. the device 102 is not predicted to arrive at the destination by the arrival time), the analyzer 122 may indicate to the recommendation engine 124 that a faster mode of transportation is to be recommended for the future trip.

In response to receiving the indication that a faster mode of transportation is to be recommended for the future trip from the analyzer 122, the recommendation engine 124 may update the mode of transportation for the future trip. The recommendation engine 124 may update the mode of transportation for the future trip with a default mode of transportation that is the fastest mode of transportation readily available to the user (i.e. does not require booking or reservation and/or that is immediately accessible to the user, such as a user's car and/or bicycle). The indication of the mode of transportation transmitted by the recommendation 124 may include the updated mode of transportation.

The recommendation engine 108 of the device 102 may receive an indication of a mode of transportation to the destination for the future trip from the server 104 via the communication circuitry 110. The recommendation engine 108 may receive the indication in response to transmitting the recommendation trigger message. The mode of transportation may include an automotive (car and/or motorcycle), walking, a bicycle, an airplane, a public transportation service (such as a public bus or buses, a public train or trains, a public subway, and/or a public light rail system), a private transportation service (such as a taxi service, a ride sharing service, a car service, a bus service, a train service, an airplane service), or some combination thereof. In some embodiments, the indication of the mode of transportation may further include an indication of whether the mode of transportation is user-operated.

The recommendation engine 108 may cause a notification for the use of the mode of transportation to be indicated by the user interface 118 based on the indication of the mode of transportation. The notification may include displaying a message on the user interface 118, displaying a visual depiction on the user interface 118, playing of a sound by the user interface 118, playing audio by the user interface 118, or some combination thereof. The notification may occur upon receipt of the indication of the mode of transportation, at a determined time prior to the arrival time of the appointment (as described further throughout this disclosure), or some combination thereof.

In some embodiments, the notification may further include an indication of a service that provides the mode of transportation. The recommendation engine 108 may identify an application and/or software on the device 102 for a service that provides the mode of transportation. The recommendation engine 108 may cause an indication of the application and/or software to be indicated by the user interface 118 within the notification. The notification may include a link to the application and/or software that, in response to being interacted with by the user, causes the application and/or software to launch. The application and/or software may open with the mode of transportation, the destination, the starting location, the arrival time at the destination, or some combination thereof, indicated and/or the corresponding field filled when launched. In some embodiments, the indication of the service may be omitted.

Further, in some embodiments, the notification may include an indication of a website that provides the mode of transportation. The recommendation engine 108 may access the website via the communication circuitry 110 and/or the information systems 150. The recommendation engine 108 may identify the website and may cause an indication of the website to be indicated by the user interface 118 within the notification. The notification may include a link to the website that, in response to being interacted with by the user, causes a browser to launch with the website. The website may open with the mode of transportation, the destination, the starting location, the arrival time at the destination, or some combination thereof, indicated and/or the corresponding field filled when launched. In some embodiments, the indication of the website may be omitted.

In some embodiments, the recommendation engine 108 may determine that the mode of transportation is a user-operated mode of transportation. The recommendation engine 108 may determine the mode of transportation is user-operated based on the indication of the mode of transportation received from the server 104, a comparison, by the recommendation engine 108, of the mode of transportation with known user-operated modes of transportation, or some combination thereof. The user-operated modes of transportation may include a bicycle, an automotive, or some combination thereof.

Based on determining that the mode of transportation is a user-operated mode of transportation, the recommendation engine 108 may provide directions to the destination. The directions may be indicated within the notification and/or the notification may include a link to the directions. The recommendation engine 108 may generate, utilize, and/or obtain directions that are mode of transportation-specific. The recommendation engine 108 may identify a map application on the device 102, a website to provide directions, or some combination thereof, and may obtain directions from the application and/or the website. In embodiments where the recommendation engine 108 utilizes the website, the recommendation engine 108 may access the website via the communication circuitry 110 and/or the information systems 150. The recommendation engine 108 may further obtain resources associated with the mode of transportation from the application and/or website, such as a parking place for an automotive in the instances where the mode of transportation is an automotive. The notification may further include an indication of the resources. In some embodiments, providing directions and/or the resources by the recommendation engine 108 may be omitted.

Further, in some embodiments, the recommendation engine 108 may change operational settings of the device 102 based on determining that the mode of transportation is a user-operated mode of transportation. For example, the recommendation engine 108 may set the device 102 to suppress indications of incoming phone calls, text messages, emails, or some combination thereof, based on the mode of transportation being user-operated. In some embodiments, the recommendation engine 108 may cause incoming phone calls to be routed directly to voice mail based on the mode of transportation being user-operated. Further, in some embodiments, the recommendation engine 108 may prevent transmission of outgoing phone calls, text messages, emails, or some combination thereof, based on the mode of transportation being user-operated. In some embodiments, changing of the operation settings of the device 102 by the recommendation engine 108 may be omitted.

In some embodiments, the recommendation engine 108 may further obtain incident reports and/or traffic reports associated with a route to be travelled by the mode of transportation. The notification may include an incident report and/or a traffic report associated with the route, a link to the incident report and/or the traffic report associated with the route, or some combination thereof. In some embodiments, the recommendation engine 108 may not obtain the incident reports and/or the traffic reports and the incident and/or the traffic report may be omitted from the notification.

In some embodiments, the recommendation engine 108 may further determine an arrival time for the device 102 at the destination and an estimated travel time to the destination based on the mode of transportation. The recommendation engine 108 may determine the estimated travel time based on information obtained from the map application and/or the website that provides directions. In some embodiments, the indication of the mode of transportation received from the server 104 may further include the estimated travel time, which the recommendation engine 108 may utilize to determine the estimated travel time.

The recommendation engine 108 may cause the notification of the mode of transportation to be indicated by the user interface 118 at a certain time based on the arrival time and the estimated travel time. The recommendation engine 108 may cause the notification to be displayed at the estimated travel time prior to the arrival time, or a certain period of time before the estimated travel time prior to the arrival time. For example, if the arrival time is 2:00 pm and the travel time is 30 minutes, the notification may be displayed at 1:30 pm or a certain period of time before 1:30 pm (such as 30 minutes before at 1:00 pm). Further, in some embodiments, the certain period of time at which the notification is indicated before the estimated travel time prior to the arrival time may be dependent on the mode of transportation. For example, if the recommendation engine 108 determines that the mode of transportation includes a service that may have booking or reservation availability, the certain period of time may be one or more months or weeks. Whereas, if the recommendation engine 108 determines that the mode of transportation does not include and/or require booking or reservation, the certain period of time may be in minutes, such as 15 minutes or 30 minutes. The recommendation engine 108 may further cause the notification to be displayed both at the certain time period before the estimated travel time prior to the arrival time and at the estimated travel time prior to the arrival time. In other embodiments, the notification may be indicated at a time independent from the arrival time and/or the estimated travel time.

Further, the recommendation engine 108 may determine whether the user utilized and/or is planning to utilize the recommended mode of transportation for the future trip. The notification of the mode of transportation may include a deny recommendation element (such as a button on the user interface, an audio denial input, or some combination thereof), which, in response to interaction by the user, may indicate that the user is not planning to utilize the recommended mode of transportation. The recommendation engine 108 may determine that the user is not planning to utilize the recommended mode of transportation based on user interaction with the deny recommendation element. In some embodiments, the recommendation engine 108 may utilize data captured by the sensor devices 114 and/or a location of the device 102 during the future trip to determine that the user did not utilize and/or is not utilizing the recommended mode of transportation. In response to determining that the user did not utilize, is not utilizing, and/or is planning not to utilize the recommended mode of transportation, the recommendation engine 108 may transmit an indication that the user did not utilize the mode of transportation to the server 104. In some embodiments, the recommendation engine 108 may forgo determining whether the user utilized the recommended mode of transportation and transmitting the indication that the user did not utilize the recommended mode of transportation.

In some embodiments, the device 102 may record user state information associated with the device 102 and the server 104 may update and/or generate new classifications within the classification data store 128 based on the recorded user state information associated with the device 102. The updated and/or new classifications produced by the server 104 may be utilized to determine a mode of transportation for future trips of the user associated with the device 102. For example, the classification data store 128 described above for determining the mode of transportation may have been generated by the server 104 based on prior trips identified within the user state information associated with the device 102.

When powered on, the recommendation engine 108 of the device 102 may record user state information associated with the device 102. The user state information may be recorded on the memory device 112 of the device 102. The user state information may include a location of the device 102, data sensed by the sensor devices 114 (such as acceleration of the device 102, a speed and/or velocity at which the device 102 is travelling, an orientation of the device 102, and/or a trajectory of the device 102), use of applications and/or software associated with modes of transportation used by the device 102, use of websites associated with modes of transportation used by the device 102, or some combination thereof. The user state information may include user state information entries collected at one or more discrete times and may include timestamps corresponding to each of the user state information entries. For example, one user state information entry may include a location of the device 102, an acceleration of the device 102, a speed and/or velocity of the device 102, an orientation of the device 102, a trajectory of the device 102, a timestamp, or some combination thereof, at the time that the user state information entry was captured.

In some embodiments, the recommendation engine 108 may record the user state information in response to certain conditions, such as when the speed and/or velocity at which the device 102 is travelling is determined to be non-zero. These embodiments may store less information than when the device 102 is continually recording when powered on. The embodiments may have a tradeoff of capturing less information, while using less storage space for the user state information.

The recommendation engine 108 may transmit at least a portion of the user state information from the memory device 112 to the server 104 via the communication circuitry 110. The recommendation engine 108 may transmit the entirety of the stored user state information to the server 104. In some embodiments, the recommendation engine 108 may transmit a portion of the stored user state information less than the entirety based on a determination that the portion may be associated with a prior trip travelled and a different portion of the data may not be associated with a prior trip. The recommendation engine 108 may determine which portion of the stored user state information may be associated with the prior trip based on information included in the stored user state information, including a location of the device 102, a speed and/or velocity of the device 102, an acceleration of the device 102, an orientation of the device 102, a trajectory of the device 102, a timestamp, or some combination thereof, associated with a stored user state information entry.

The recommendation engine 108 may transmit the stored user state information to the server 104 at set intervals. For example, the recommendation engine 108 may transmit the stored user state information every 1 hour, 12 hours, or 24 hours. In some embodiments, the recommendation engine 108 may continuously transmit the stored user state information to the server 104 at the time that the user state information is stored. The recommendation engine 108 may further delete, or cause to be deleted, the transmitted user state information in response to the recommendation engine 108 transmitting the user state information to the server 104, thereby freeing up space to store additional user state information.

The server 104 may receive the user state information transmitted by the device 102 via the communication circuitry 120. The server 104 may store the received user state information in the database 126 as recorded data associated with the user. The database 126 may include recorded data associated with multiple users and may store the data for each user in different portions of the database 126 and/or include indicators with the recorded data to indicate the user associated with each portion of the recorded data.

The analyzer 122 may access the user state information stored within the database 126 and analyze the user state information to identify one or more prior trips within the recorded data. The analyzer 122 may identify prior trips based on the information within the recorded data, including a location of the device 102, a speed and/or velocity of the device 102, an acceleration of the device 102, an orientation of the device 102, a trajectory of the device 102, a timestamp, use of applications and/or software associated with modes of transportation used by the device 102, use of websites associated with modes of transportation used by the device 102, or some combination thereof, associated with a stored user state information entry. For example, the analyzer 122 may identify a first recorded data entry that indicates the device 102 was stopped at a first location for a minimum period of time, a second recorded data entry (with a subsequent timestamp to the timestamp of the first recorded data entry) that indicates that the device 102 was stopped at a second location for the minimum period of time, and one or more recorded data entries (with timestamps between the timestamp of the first recorded data entry and the timestamp of the second recorded data entry) that indicate that the device 102 was moving. The analyzer 122 may identify the prior trip based on the identification of the first recorded data entry, the second recorded data entry, and the one or more recorded data entries (collectively referred to as ‘the recorded data associated with the prior trip’).

In response to the analyzer 122 identifying the prior trip, the analyzer 122 may determine one or more characteristics associated with the prior trip. The characteristics may include a starting location (as may be determined by the analyzer 122 based on a location associated with the first recorded data), a destination (as may be determined by the analyzer 122 based on a location associated with the second recorded data), a route the device 102 travelled between the starting location and the destination, a travel time between the starting location and the destination (as may be determined by the analyzer 122 based on timestamps associated with the starting location and the destination), a time of day of the prior trip (as may be determined by the analyzer 122 based on timestamps associated with the starting location and/or the destination), a day of the week of the prior trip (as may be determined by the analyzer 122 based on timestamps associated with the starting location and/or the destination), a date of the prior trip, preferences of the user associated with the prior trip, a mode of transportation utilized for the prior trip, applications and/or software associated with modes of transportation used by the device 102, websites associated with modes of transportation used by the device 102, or some combination thereof.

The analyzer 122 may determine the mode of transportation utilized for the prior trip based on the information within the recorded data associated with the prior trip. The analyzer 122 may determine the mode of transportation based on a speed and/or velocity of the device 102, an acceleration of the device 102, a location of the device 102 (which may include an elevation of the device 102), an orientation of the device 102, a trajectory of the device 102, a route of the device 102, or some combination thereof, during the prior trip. For example, the analyzer 122 may determine that the mode of transportation utilized for the prior trip was a car based on the speed and/or velocity of the device 102 during the trip being above a certain speed and/or velocity, whereas the analyzer 122 may determine that the mode of transportation was walking based on the speed and/or velocity of the device staying below the certain speed and/or velocity for the entirety of the prior trip. For another example, the analyzer 122 may determine that the mode of transportation utilized for the prior trip was a certain mode of public transportation (such as bus, subway, light rail, or train) based one or more stops along the route of the device 102 during the prior trip.

The analyzer 122 may further obtain further information from the information systems 150, via the communication circuitry 120, for determination of the mode transportation. The analyzer 122 may obtain route and/or schedule information for public transportation from the information systems 150. The analyzer 122 may compare the route information for the public transportation with the route of the device 102 during the prior trip and determine that the mode of transportation was a certain mode of public transportation (such as bus, subway, light rail, or train) based on the comparison. In some embodiments, the analyzer 122 may compare the schedule information for public transportation with a starting time (as may be determined by the analyzer 122 based on a timestamp associated with the recorded data), an arrival time (as may be determined by the analyzer 122 based on a timestamp associated with the second recorded data), and/or stops along the route of the device 102 during the prior trip. The analyzer 122 may determine that the mode of transportation was a certain mode of public transportation based on the comparison with the schedule information.

In some embodiments, the analyzer 122 may supplement the characteristics determined from the recorded data associated with the prior trip with additional characteristics obtained from the information systems 150 via the communication circuitry 120. The analyzer 122 may obtain weather information, traffic information, public transportation information (including identifiers for certain modes of public transportation utilized for the prior trip), or some combination thereof, from the information systems 150. The analyzer 122 may associate the obtained information from the information systems 150 as characteristics for the prior trip.

The analyzer 122 may generate a classification or update a classification stored in the classification data store 128 based on the prior trip. For generation of the classification, the analyzer 122 may generate the classification based on the one or more characteristics determined to be associated with the prior trip. The classification may include indications of the one or more characteristics, which may be used for classification of future trips (as described above). Further, the analyzer 122 may associate the mode of transportation utilized for the prior trip with the classification. The analyzer 122 may store the classification in the classification data store 128 within the database 126. The stored classification may be associated with the user of the device 102 during the prior trip.

For update of the classification, the analyzer 122 may identify a classification stored within the classification data store 128 based on one or more common characteristics between the characteristics associated with the prior trip and the characteristics associated with the stored classification. The analyzer 122 may update the stored classification with one or more the characteristics associated with the prior trip.

In some embodiments, the device 102 perform one or more of the features described above as being performed by the server 104. In particular, the analyzer 106 may perform one or more of the features performed by the analyzer 122, the recommendation engine 108 may perform one or more of the features performed by the recommendation engine 124, the memory device 112 may store one or more of the features stored by the database 126 (including the classification data store 128), or some combination thereof. For example, in some embodiments, the server 104 may be omitted, and the analyzer 106, the recommendation engine 108, and the memory device 112 may perform and/or store all the features performed and/or stored by the analyzer 122, the recommendation engine 124, and the database 126, respectively.

Further, in some embodiments, the server 104 may perform the classification of prior trips and may transmit the classifications to the device 102 for storage on the memory device 112. In these embodiments, the device 102 may determine the characteristics associated with a future trip, identify the classification from the classifications stored on the memory device 112, and may determine the mode of transportation for the future trip based on the identified classification. In particular, the analyzer 106 may perform the features of the analyzer 122 and the recommendation engine 108 may perform the features of the recommendation engine 124 associated with determining the characteristics associated with a future trip, identifying the classification from the classifications stored on the memory device 112, and determining the mode of transportation for the future trip based on the identified classification

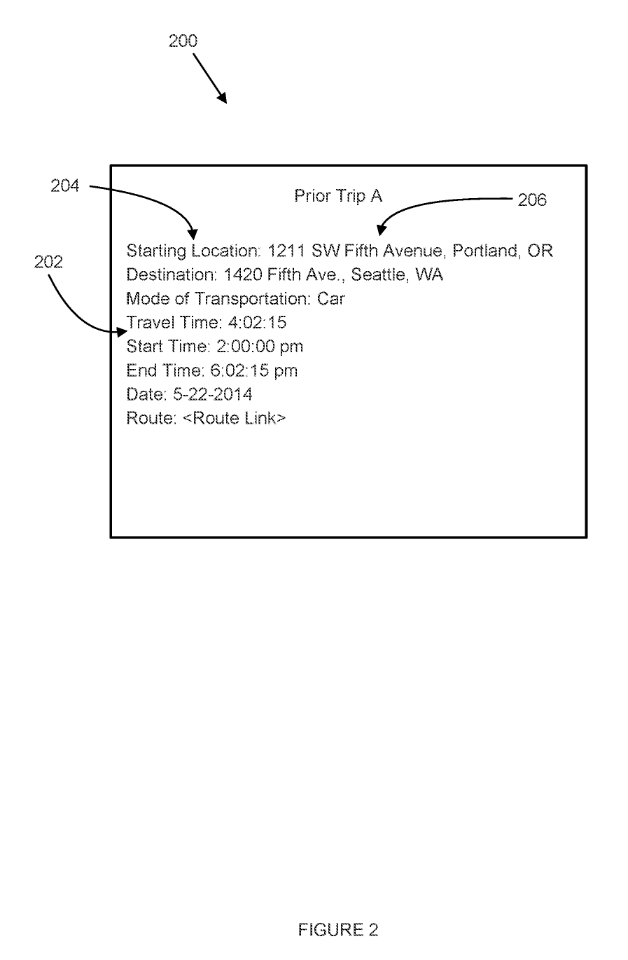

FIG. 2 illustrates an example identified prior trip entry 200, according to various embodiments. The prior trip entry 200 may be representative of the prior trip as identified by the server 104 (FIG. 1), as described in relation to FIG. 1. The analyzer 122 (FIG. 1) may generate the prior trip entry 200 in response to identifying the prior trip within the recorded data. The prior trip entry 200 may be utilized in generating a classification and/or updating a stored classification of the classification data store 128 (FIG. 1). In some embodiments, the analyzer 122 may not generate the prior trip entry 200, although the prior trip entry 200 may be representative of the characteristics utilized for generating the classification and/or updating the stored classification.

The prior trip entry 200 illustrated may be associated with a prior trip, labeled ‘prior trip A.’ The prior trip entry 200 may include one or more characteristics 202 associated with the prior trip A. The one or more characteristics 202 may include a starting location, a destination, a mode of transportation, a travel time, a start time, an end time, a date, a day of the week, a route, other characteristics described in relation to prior trips in the description of FIG. 1, or some combination thereof, associated with the prior trip A. The characteristics 202 may be determined based on, derived from, and/or identified from the recorded data and/or the information obtained from the information systems 150 (FIG. 1), as described in relation to FIG. 1.

Each of the characteristics 202 may include a field 204 and a value 206 associated with the field 204. The field 204 may include a descriptor of one of the characteristics associated with the prior trip and the value 206 may include a value of the one of the characteristics associated with the prior trip. The fields 204 may be generated based on the information within the recorded data and the corresponding values 206 may be stored in association with the fields 204. In the illustrated example, one field 204 is a ‘Starting Location’ field that has a corresponding value 206 of ‘1211 SW Fifth Avenue, Portland, Oreg.’ It is to be understood that additional or less fields 204 and corresponding values 206 may be included in the characteristics 202 than shown in the illustrated example.

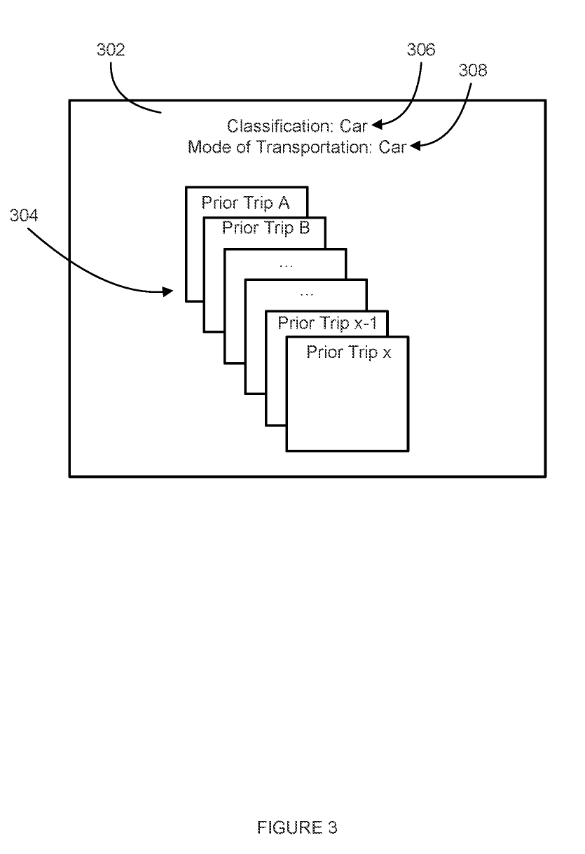

FIG. 3 illustrates an example relationship between a classification 302 and prior trips 304, according to various embodiments. One or more prior trips 304 may be associated with a classification 302 (as illustrated by inclusion of the prior trips 304 within the classification 302). The classification 302 may include a value 306 associated with the classification 302. In the illustrated classification 302, the value 306 is ‘Car.’ However, it is to be understood that the value 306 may be any of the characteristics 202 (FIG. 2), any of the characteristics described in relation to FIG. 1, or a random value unrelated to the characteristics.

The prior trips 304 may be associated with the classification 302 as described in relation to FIG. 1. In particular, the each of the prior trips 304 may include one or more common characteristics. The prior trips 304 may be associated with the classification 302 based on one or more of these common characteristics. The characteristics may be any of the characteristics 202, any of the characteristics described in relation to FIG. 1, or some combination thereof.

A mode of transportation 308 may be associated with the classification 302. The mode of transportation 308 may be a mode of transportation associated with the prior trips 304, a mode of transportation associated with a majority of the prior trips 304, a mode of transportation associated with the prior trips 304 that appears with a greatest frequency, or some combination thereof. The mode of transportation 308 may include any of the modes of transportation described in relation to FIG. 1, including an automotive (car and/or motorcycle), walking, a bicycle, an airplane, a public transportation service (such as a public bus or buses, a public train or trains, a public subway, and/or a public light rail system), a private transportation service (such as a taxi service, a ride sharing service, a car service, a bus service, a train service, an airplane service), or some combination thereof. In the illustrated embodiment, the mode of transportation 308 is a car. As additional prior trips 304 are associated with the classification 302, the mode of transportation 308 may be updated based on the addition of the prior trips 304. In some embodiments, the value 306 of the classification 302 may be set equal to the mode of transportation 308 and may be updated with the mode of transportation 308.

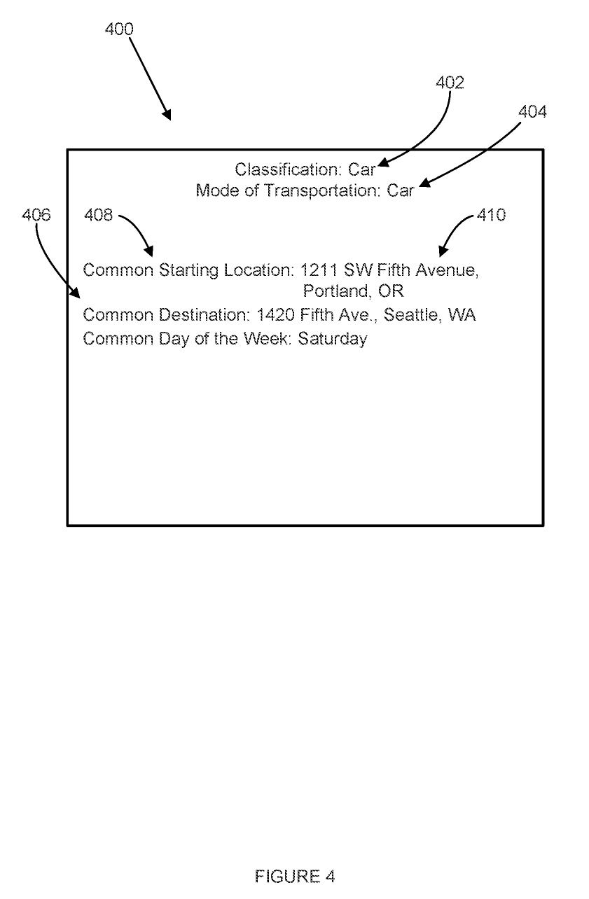

FIG. 4 illustrates an example classification 400, according to various embodiments. The classification 400 may include a value 402 and a mode of transportation 404 associated with the classification. The value 402 may include one or more of the features of the value 306 (FIG. 3). Further, the mode of transportation 404 may include one or more of the features of the mode of transportation 308 (FIG. 3).

The classification 400 may include one or more common characteristics 406. The common characteristics 406 may be determined and/or generated, by the analyzer 122 (FIG. 1), based on characteristics of prior trips associated with the classification 400. The prior trips may include one or more of the features of the prior trips 304 (FIG. 3). The common characteristics 406 may include characteristics common to all of the prior trips associated with the classification 400, a majority of the prior trips associated with the classification, a certain percentage of the prior trips associated with the classification, or some combination thereof.

Each of the common characteristics 406 may include a field 408 and a corresponding value 410. The field 408 may include a descriptor of one of the common characteristics 406 associated with the classification 400 and the value 410 may include a value of the one of the common characteristics 406. In the illustrated example, one of the fields 408 is ‘Common Starting Location’ and the corresponding value 410 is ‘1211 SW Fifth Avenue, Portland, Oreg.’ It is to be understood that additional or less fields 408 and corresponding values 410 may be included in the common characteristics 406 than shown in the illustrated example.

As the analyzer 122 identifies additional prior trips associated with the classification 400, one or more features of the classification 400 may be updated. In particular, additional characteristics may be added to the common characteristics 406 based on the additional trips and/or existing characteristics may be removed from the common characteristics 406 based on the additional trips. Additionally, the mode of transportation 404 may be updated based on the additional trips.

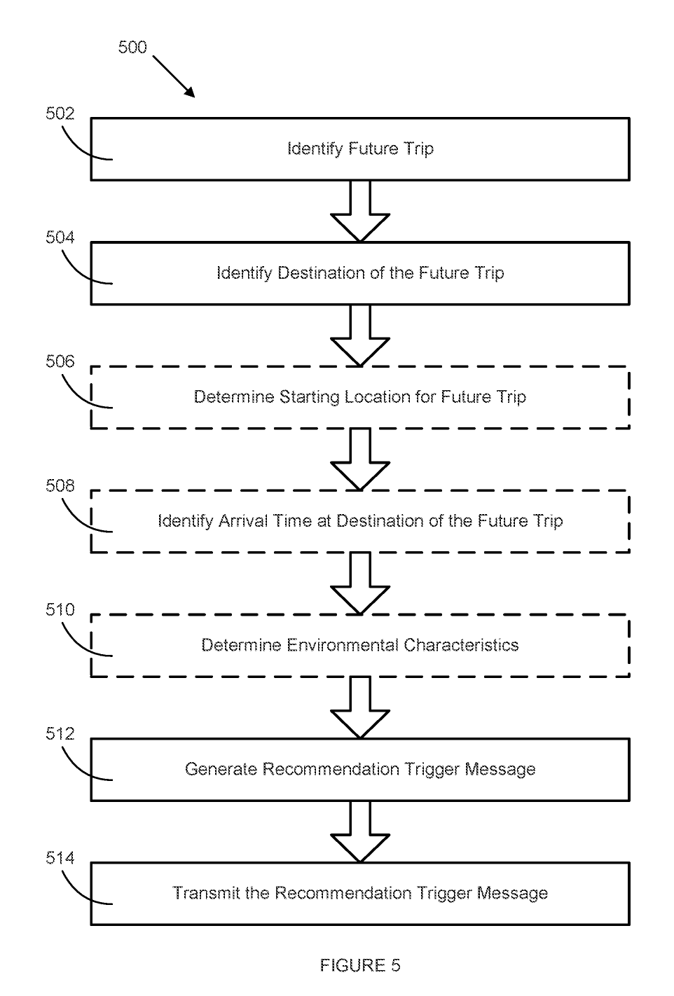

FIG. 5 illustrates an example procedure 500 for generation of a recommendation trigger message, according to various embodiments. The procedure 500 may be performed by the device 102 (FIG. 1).

In stage 502, the device 102 may identify a future trip to be travelled by the user of the device 102. The identification of the future trip may include one or more of the features of identifying a future trip described in relation to FIG. 1, including identifying a future trip from the user's appointment information. The analyzer 106 (FIG. 1) of the device 102 may identify the future trip, as described in relation to FIG. 1.

In stage 504, the device 102 may identify a destination of the future trip. The identification of the destination may include one or more of the features of identifying the destination of the future trip as described in relation to FIG. 1. In some embodiments, the destination may be determined based on a location of an appointment utilized to identify the future trip. The recommendation engine 108 (FIG. 1) may identify the destination of the future trip, as described in relation to FIG. 1.

In stage 506, the device 102 may identify a starting location of the future trip. The identification of the starting location may include one or more of the features of identifying the starting location as described in relation to FIG. 1. In some embodiments, the starting location may be identified based on a current location of the device 102, a temporally adjacent appointment to the appointment associated with the future trip, or some combination thereof. The recommendation engine 108 may identify the starting location, as described in relation to FIG. 1. In some embodiments, stage 506 may be omitted.

In stage 508, the device 102 may identify an arrival time at the destination of the future trip. The identification of the arrival time may include one or more of the features of identifying the arrival time, as described in relation to FIG. 1. In some embodiments, the arrival time may be identified based on a time of the appointment associated with the future trip. The recommendation engine 108 may identify the arrival time, as described in relation to FIG. 1. In some embodiments, stage 508 may be omitted.

In stage 510, the device 102 may identify additional information associated with the future trip. The identification of additional information may include obtaining information from the information systems 150 (FIG. 1) and identifying and/or determining additional information based on the information obtained from the information systems 150, as described in relation to FIG. 1. Further, identification of additional information may include identifying preferences of the user described in relation to FIG. 1. The recommendation engine 108 may identify the additional information, as described in relation to FIG. 1. In some embodiments, stage 510 may be omitted.

In stage 512, the device 102 may generate a recommendation trigger message. The recommendation trigger message may include one or more of the features of the recommendation trigger message described in relation to FIG. 1, and may include the information included in the recommendation trigger message described in relation to FIG. 1. The recommendation engine 108 may generate the recommendation trigger message, as described in relation to FIG. 1.

In stage 514, the device 102 may transmit the recommendation trigger message to the server 104 (FIG. 1). The recommendation engine 108 may transmit, or may cause to be transmitted, the recommendation trigger message via the communication circuitry 110 (FIG. 1) of the device 102.

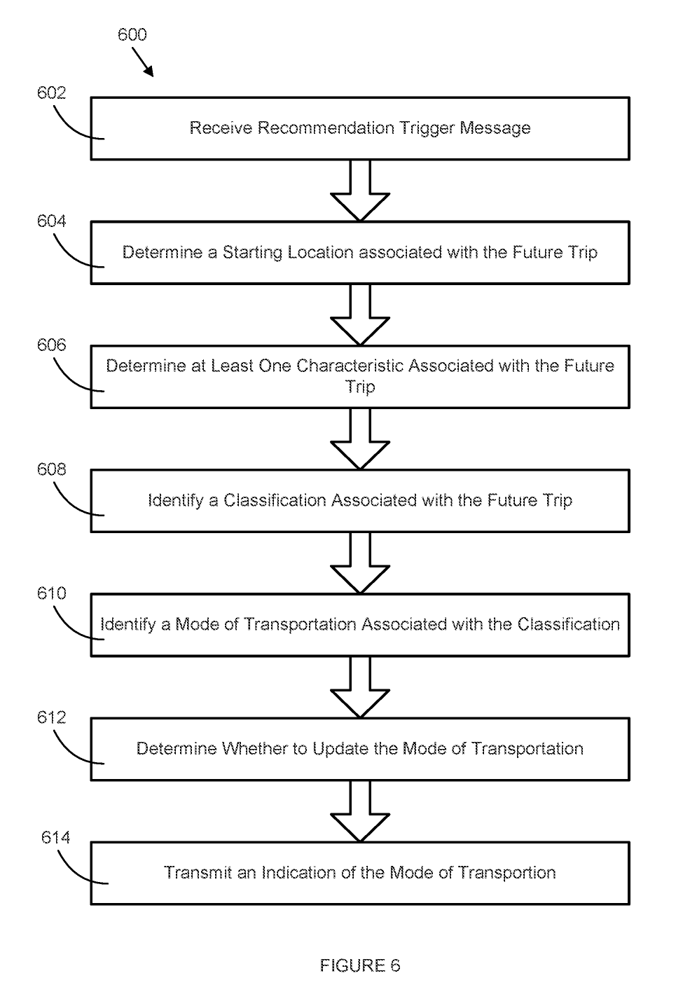

FIG. 6 illustrates an example procedure 600 for identification of a mode of transportation for a future trip, according to various embodiments. The procedure 600 may be performed by the server 104 (FIG. 1).

In stage 602, the server 104 may receive the recommendation trigger message transmitted from the device 102 (FIG. 1). The recommendation trigger message may include one or more of the features of the recommendation trigger message described in relation to FIG. 1, the recommendation trigger message transmitted in stage 504 (FIG. 5) of the procedure 500 (FIG. 5), or some combination thereof. The server 104 may receive the recommendation trigger message via the communication circuitry 120 (FIG. 1).

In stage 604, the server 104 may determine a starting location associated with the future trip. The determination of the starting location may include one or more of the feature of determining the starting location described in relation to FIG. 1. In some embodiments, the starting location may be determined based on information within the recommendation trigger message, information obtained from the information systems 150 (FIG. 1), or some combination thereof. The analyzer 122 may determine the starting location, as described in relation to FIG. 1.

In stage 606, the server 104 may determine at least one characteristic associated with the future trip. The determination of the characteristic may include one or more of the features of determining the at least one characteristic described in relation to FIG. 1, and the characteristic may include one or more of the characteristics determined by the server 104 described in relation to FIG. 1. In some embodiments, determining the characteristics may include identifying and/or deriving the characteristics from the information included in the recommendation trigger message, identifying and/or deriving the characteristics from information obtained from the information systems 150, or some combination thereof. The analyzer 122 may determine the at least one characteristic, as described in relation to FIG. 1.

In stage 608, the server 104 may identify a classification associated with the future trip. The identification of the classification may include one or more of the features of identifying the classification described in relation to FIG. 1. In embodiments, the identification of the classification may include comparing the characteristics associated with the future trip with characteristics associated with the classification data store 128 (FIG. 1) to identify the classification associated with the future trip. The recommendation engine 124 (FIG. 1) may receive the characteristics associated with the future trip from the analyzer 122 and identify the classification associated with the future trip based on the characteristics, as described in relation to FIG. 1.

In stage 610, the server 104 may identify a mode of transportation associated with the future trip. The identification of the mode of transportation may include one or more of the features of identifying the mode of transportation described in relation to FIG. 1. In some embodiments, the server 104 may identify a mode of transportation associated with the classification that was identified as being associated with the future trip and determine that the identified mode of transportation is to be associated with the future trip. The recommendation engine 124 may identify the mode of transportation, as described in relation to FIG. 1.

In stage 612, the server 104 may determine whether to update the mode of transportation associated with the future trip. The determination of whether to update the mode of transportation may include one or more of the features of determining whether to update the mode of transportation described in relation to FIG. 1. In some embodiments, the server 104 may compare a travel time from the starting location to the destination associated with the current mode of transportation to a time difference between the current time and the arrival time at the destination to determine whether to update the mode of transportation. In response to determining the mode of transportation should be updated, the server 104 may update the mode of transportation associated with the future trip to be a faster mode of transportation, as described in relation to FIG. 1. The analyzer 122 may determine whether the mode of transportation associated with the future is to be updated and the recommendation engine 124 may update the mode of transportation in response to determining that the mode of transportation should be updated, as described in relation to FIG. 1. In some embodiments, stage 612 may be omitted.

In stage 614, the server 104 may transmit an indication of the mode of transportation to the device 102. The transmission of the indication of the mode of transportation may include one or more of the features of transmitting the indication of the mode of transportation described in relation to FIG. 1, and the indication of the mode of transportation may include one or more of the features of the indication of the mode of transportation described in relation to FIG. 1. The recommendation engine 124 may transmit, or cause to be transmitted, the indication of the mode of transportation to the device 102 via the communication circuitry 120, as described in relation to FIG. 1.

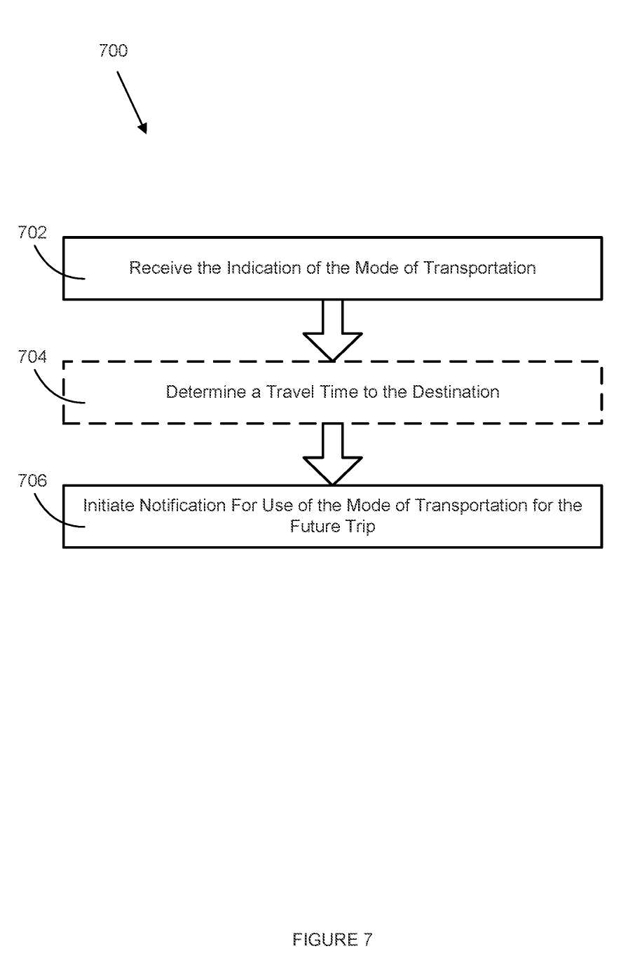

FIG. 7 illustrates an example procedure 700 for initiation of a notification of the mode of transportation for the future trip, according to various embodiments. The procedure 700 may be performed by the device 102 (FIG. 1).

In stage 702, the device 102 may receive the indication of the mode of transportation associated with the future trip from the server 104 (FIG. 1). The indication of the mode of transportation may include one or more of the features of the indication of the mode of transportation described in relation to FIG. 1, the indication of the mode of transportation transmitted by the server 104 in stage 614 (FIG. 6) of the procedure 600 (FIG. 6), or some combination thereof. The device 102 may receive the indication of the mode of transportation via the communication circuitry 120 (FIG. 1).

In stage 704, the device 102 may determine a travel time to the destination of the future trip based on the mode of transportation within the indication. The determination of the travel time may include one or more of the features of determining the mode of transportation described in relation to FIG. 1. In some embodiments, the device 102 may determine the travel time based on information obtained from the information systems 150. The recommendation engine 108 may determine the travel time, as described in relation to FIG. 1. In some embodiments, stage 704 may be omitted.

In stage 706, the device 102 may initiate notification for use of the mode of transportation for the future trip. The initiation of the notification may include one or more of the features of initiating the notification for use of the mode of transportation described in relation to FIG. 1. In some embodiments, the device 102 may cause the user interface 118 (FIG. 1) to indicate the notification to a user of the device 102. The recommendation engine 108 may cause the user interface 118 to indicate the notification for the use of the mode of transportation, as described in relation to FIG. 1, including the timing of the notification being indicated by the user interface 118.

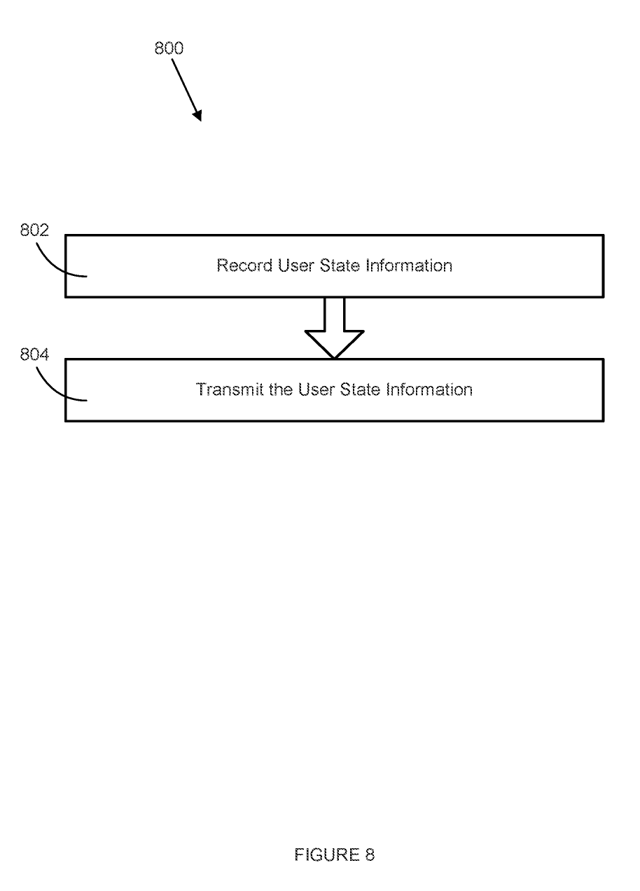

FIG. 8 illustrates an example procedure 800 for recording user state information, according to various embodiments. The procedure 800 may be performed by the device 102 (FIG. 1).

In stage 802, the device 102 may record user state information associated with the device 102. The recordation of the user state information may include one or more of the feature of recording user state information described in relation to FIG. 1. The user state information may include one or more of the features of the user state information described in relation to FIG. 1, including the information sensed by the sensor devices 114 (FIG. 1) and/or the location of the device 102. In some embodiments, the device 102 may record the user state information while the device 102 is turned on and store the user state information to the memory device 112 (FIG. 1). The recommendation engine 108 (FIG. 1) may record the user state information and store the recorded user state information to the memory device 112, as described in relation to FIG. 1.

In stage 804, the device 102 may transmit the user state information to the server 104 (FIG. 1) via the communication circuitry 110 (FIG. 1). The transmission of the user state information may include one or more of the features of transmitting the user state information as described in relation to FIG. 1. In some embodiments, the device 102 may transmit an entirety of the user state information or a portion of the user state information, wherein the device 102 may delete the transmitted user state information from the memory device 112 in response to transmitting the user state information. The device 102 may transmit the user state information at set intervals or continuously. The recommendation engine 108 may transmit the user state information, as described in relation to FIG. 1.

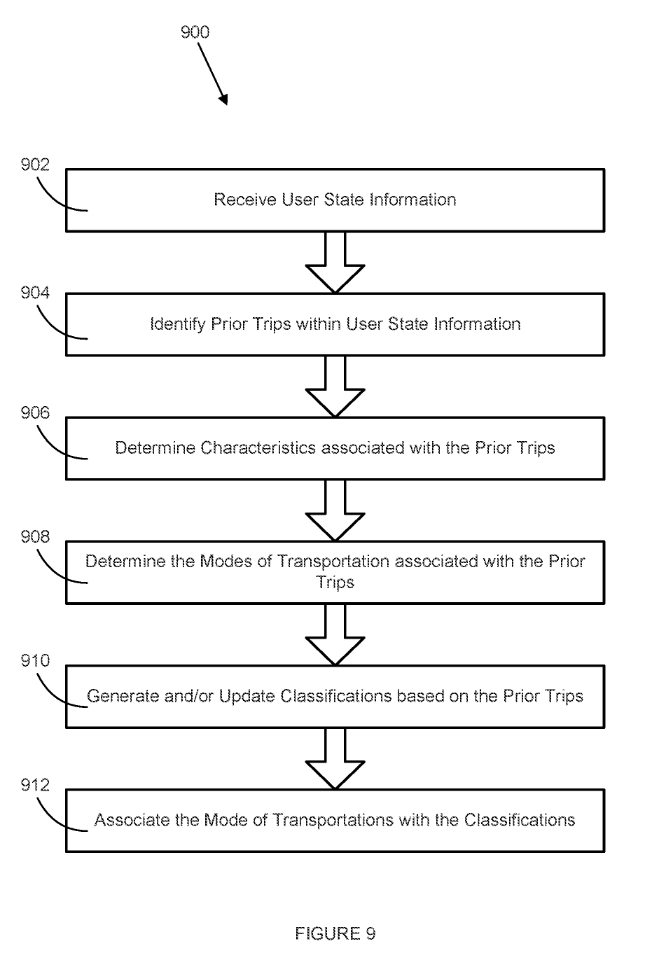

FIG. 9 illustrates an example procedure 900 for associating a mode of transportation with a classification, according to various embodiments. The procedure 900 may be performed by the server 104 (FIG. 1).

In stage 902, the server 104 may receive user state information from the device 102 (FIG. 1) via the communication circuitry 120 (FIG. 1). The user state information may include one or more of the features of the user state information described in relation to FIG. 1, the user state information transmitted by the device 102 in stage 804 (FIG. 8) of the procedure 800 (FIG. 8), or some combination thereof. The server 104 may store the user state information in the database 126 (FIG. 1) as recorded data associated with a user of the device 102.

In stage 904, the server 104 may access the recorded data started in the database 126 and identify one or more prior trips within the recorded data. The identification of the prior trips may include one or more of the features of identifying the prior trips described in relation to FIG. 1. The analyzer 122 (FIG. 1) may access the recorded data and identify the one or more prior trips, as described in relation to FIG. 1.

In stage 906, the server 104 may determine characteristics associated with the prior trips. The determination of the characteristics may include one or of the features of determining the characteristics associated with the prior trips described in relation to FIG. 1, including determining the characteristics from the recorded data, determining the characteristics based on information obtained from the information systems 150 (FIG. 1), or some combination thereof. The characteristics may include one or more of the characteristics described in relation to FIG. 1. The analyzer 122 may determine the characteristics associated with the prior trips, as described in relation to FIG. 1.

In stage 908, the server 104 may determine the modes of transportation associated with the prior trips. The determination of the modes of transportation may include one or more of the features of determining the modes of transportation associated with prior trips described in relation to FIG. 1. The server 104 may determine a certain mode of transportation for each of the prior trips. The modes of transportation may include one or more of the modes of transportation described in relation to FIG. 1, including an automotive (car and/or motorcycle), walking, a bicycle, an airplane, a public transportation service (such as a public bus or buses, a public train or trains, a public subway, and/or a public light rail system), a private transportation service (such as a taxi service, a ride sharing service, a car service, a bus service, a train service, an airplane service), or some combination thereof. The analyzer 122 may determine the modes of transportation associated with the prior trips, as described in relation to FIG. 1.

In stage 910, the server 104 may generate and/or update classifications based on the prior trips. The generation and/or update of the classifications may include one or more of the features of generating and/or updating the classifications described in relation to FIG. 1. In some embodiments, the server 104 may generate and/or update the classifications based on the characteristics associated with the prior trips. The analyzer 122 may generate and/or update the classifications based on the prior trips, as described in relation to FIG. 1.

In stage 912, the server 104 may associated the modes of transportation with the classifications generated and/or updated by the server 104. The association of the modes of transportation with the classifications may include one or more of the features of associating the modes of transportations with the classifications described in relation to FIG. 1. The analyzer 122 may associate the modes of transportation with the classification, as described in relation to FIG. 1.

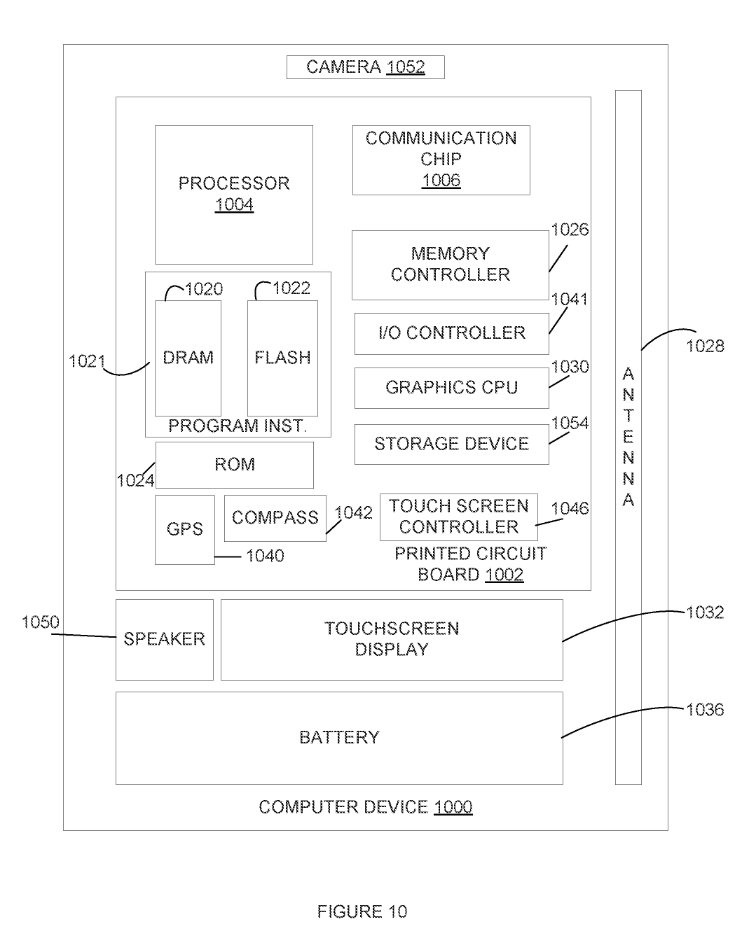

FIG. 10 illustrates an example computer device 1000 that may employ the apparatuses and/or methods described herein (e.g., the device 102, the server 104, the information systems 150, the procedure 500, the procedure 600, the procedure 700, the procedure 800, and/or the procedure 900), in accordance with various embodiments. As shown, computer device 1000 may include a number of components, such as one or more processor(s) 1004 (one shown) and at least one communication chip 1006. In various embodiments, the one or more processor(s) 1004 each may include one or more processor cores. In various embodiments, the at least one communication chip 1006 may be physically and electrically coupled to the one or more processor(s) 1004. In further implementations, the communication chip 1006 may be part of the one or more processor(s) 1004. In various embodiments, computer device 1000 may include printed circuit board (PCB) 1002. For these embodiments, the one or more processor(s) 1004 and communication chip 1006 may be disposed thereon. In alternate embodiments, the various components may be coupled without the employment of PCB 1002.

Depending on its applications, computer device 1000 may include other components that may or may not be physically and electrically coupled to the PCB 1002. These other components include, but are not limited to, memory controller 1026, volatile memory (e.g., dynamic random access memory (DRAM) 1020), non-volatile memory such as read only memory (ROM) 1024, flash memory 1022, storage device 1054 (e.g., a hard-disk drive (HDD)), an I/O controller 1041, a digital signal processor (not shown), a crypto processor (not shown), a graphics processor 1030, one or more antenna 1028, a display (not shown), a touch screen display 1032, a touch screen controller 1046, a battery 1036, an audio codec (not shown), a video codec (not shown), a global positioning system (GPS) device 1040, a compass 1042, an accelerometer (not shown), a gyroscope (not shown), a speaker 1050, a camera 1052, and a mass storage device (such as hard disk drive, a solid state drive, compact disk (CD), digital versatile disk (DVD)) (not shown), and so forth.

In some embodiments, the one or more processor(s) 1004, flash memory 1022, and/or storage device 1054 may include associated firmware (not shown) storing programming instructions 1021 configured to enable computer device 1000, in response to execution of the programming instructions by one or more processor(s) 1004, to practice all or selected aspects of the methods described herein. In various embodiments, these aspects may additionally or alternatively be implemented using hardware separate from the one or more processor(s) 1004, flash memory 1022, or storage device 1054.

The communication chips 1006 may enable wired and/or wireless communications for the transfer of data to and from the computer device 1000. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1006 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1000 may include a plurality of communication chips 1006. For instance, a first communication chip 1006 may be dedicated to shorter range wireless communications such as Wi-Fi and Bluetooth, and a second communication chip 1006 may be dedicated to longer range wireless communications such as GPS, EDGE, GPRS, CDMA, WiMAX, LTE, Ev-DO, and others.

In various implementations, the computer device 1000 may be a laptop, a netbook, a notebook, an ultrabook, a smartphone, a computer tablet, a personal digital assistant (PDA), an ultra-mobile PC, a mobile phone, a desktop computer, a server, a printer, a scanner, a monitor, a set-top box, an entertainment control unit (e.g., a gaming console or automotive entertainment unit), a digital camera, an appliance, a portable music player, or a digital video recorder. In further implementations, the computer device 1000 may be any other electronic device that processes data.

Example 1 may include a device, comprising communication circuitry to communicate with a server, a user interface to interact with a user of the device, an analyzer to identify a future trip to be travelled by the user, and identify a destination associated with the future trip, and a recommendation engine to transmit, to the server via the communication circuitry, a recommendation trigger message that includes an indication of the destination, receive, from the server via the communication circuitry, an indication of a mode of transportation to the destination, the indication of the mode of transportation based on prior trip information of the user, and cause a notification for use of the mode of transportation to the destination to be indicated by the user interface.

Example 2 may include the device of example 1, wherein, to identify the future trip, the analyzer is to identify an appointment in a calendar application, and determine that the future trip is to be travelled by the user to attend the appointment.

Example 3 may include the device of any of the examples 1 and 2, wherein the analyzer is to further identify, on the device, an application for a service that provides the mode of transportation, wherein the notification for use of the mode of transportation includes an indication of the application.

Example 4 may include the device of example 3, wherein the indication of the application includes a link to the application.

Example 5 may include the device of any of the examples 1 and 2, wherein the recommendation engine is to further determine that the mode of transportation is a user-operated mode of transportation, and provide directions to the destination based on the mode of transportation being the user-operated mode of transportation.

Example 6 may include the device of example 5, wherein to provide the directions, the recommendation engine is to further identify, on the device, a map application, and obtain, from the map application, the directions based on the destination.

Example 7 may include the device of any of the examples 1 and 2, wherein the recommendation engine is to further determine a current location of the device, wherein the recommendation trigger message further includes an indication of the current location.

Example 8 may include the device of any of the examples 1 and 2, wherein the recommendation engine is to further determine an arrival time for the device at the destination, and determine, based on the mode of transportation, an estimated travel time to the destination, wherein the notification for use of the mode of transportation is displayed at a time based on the arrival time and the estimated travel time.

Example 9 may include the device of any of the examples 1 and 2, further comprising a memory device coupled to the analyzer and the recommendation engine, wherein the recommendation engine is to further record user state information to the memory device, and transmit, to the server via the communication circuitry, at least a portion of the user state information from the memory device, the at least the portion of the user state information used by the server for generation of one or more classifications associated with one or more modes of transportation.

Example 10 may include the device of example 9, further comprising a sensor device, wherein the user state information includes sensor data obtained from the sensor device.

Example 11 may include the device of example 10, wherein sensor device includes an accelerometer or a gyroscope.

Example 12 may include the device of example 9, wherein the user state information includes one or more locations where the device was located and one or more timestamps corresponding to each of the one or more locations.

Example 13 may include the device of any of the examples 1 and 2, wherein the analyzer is to further identify a denial of the use of the mode of transportation to the destination received in response to the notification, and the recommendation engine is to further transmit, to the server via the communication circuitry, an indication that the use of the mode of transportation to the destination was denied.

Example 14 may include the device of any of the examples 1 and 2, wherein user interface is to display a message on the user interface, play a sound, or play an audio message as the notification for use of the mode of transportation to the destination.

Example 15 may include the device of any of the examples 1 and 2, wherein the device is a user equipment.

Example 16 may include one or more computer-readable media having instructions stored thereon, wherein the instructions, in response to execution by a travel device, cause the travel device to transmit, to a server, a recommendation trigger message that includes an indication of a destination for a user of the travel device, receive, from the server, an indication of a mode of transportation to the destination, the indication of the mode of transportation based on prior trip information of the user, and initiate, via a user interface of the travel device, a notification for use of the mode of transportation to the destination.

Example 17 may include the one or more computer-readable media of example 16, wherein the instructions, in response to execution by the travel device, further cause the device to identify, on the travel device, an application for a service that provides the mode of transportation, wherein the notification for use of the mode of transportation includes an indication of the application.

Example 18 may include the one or more computer-readable media of example 17, wherein the indication of the application includes a link to the application.

Example 19 may include the one or more computer-readable media of any of the examples 16-18, wherein the instructions, in response to execution by the travel device, further cause the device to determine that the mode of transportation is a user-operated mode of transportation, and provide directions to the destination based on the mode of transportation being the user-operated mode of transportation.

Example 20 may include the one or more computer-readable media of example 19, wherein to provide the directions includes to identify, on the travel device, a map application, and obtain, from the map application, the directions based on the destination and a current location of the travel device.

Example 21 may include the one or more computer-readable media of any of the examples 16-18, wherein the instructions, in response to execution by the travel device, further cause the travel device to determine a current location of the travel device, wherein the recommendation trigger message further includes an indication of the current location.

Example 22 may include the one or more computer-readable media of any of the examples 16-18, wherein to display the notification for use of the mode of transportation includes to determine an arrival time for intended arrival of the travel device at the destination, and determine, based on the mode of transportation, an estimated travel time from a current location of the travel device to the destination, wherein the notification for use of the mode of transportation is displayed at a time based on the arrival time and the estimated travel time.

Example 23 may include the one or more computer-readable media of any of the examples 16-18, wherein the instructions, in response to execution by the travel device, further cause the travel device to record user state information, and transmit, to the server, at least a portion of the user state information, the at least the portion of the user state information used by the server for generation of one or more classifications associated with one or more modes of transportation.

Example 24 may include the one or more computer-readable media of example 23, wherein the user state information includes sensor data obtained from at least one sensor device of the travel device.

Example 25 may include the one or more computer-readable media of example 24, wherein the at least one sensor device includes an accelerometer or a gyroscope.

Example 26 may include the one or more computer-readable media of example 23, wherein the user state information includes one or more locations where the travel device was located and one or more timestamps corresponding to each of the one or more locations.

Example 27 may include the one or more computer-readable media of any of the examples 16-18, wherein the instructions, in response to execution by the travel device, further cause the travel device to identify a denial of the use of the mode of transportation to the destination received in response to the notification, and transmit, to the server, an indication that the use of the mode of transportation to the destination was denied.

Example 28 may include the one or more computer-readable media of any of the examples 16-18, wherein to initiate the notification for use of the mode of transportation includes to display, on the user interface, the notification for use of the mode of transportation, play, via the user interface, a sound associated with the notification for use of the mode of transportation, or play, via the user interface, an audio message associated with the notification for use of the mode of transportation.

Example 29 may include the one or more computer-readable media of any of the examples 16-18, wherein the travel device is a user equipment.

Example 30 may include a server, comprising communication circuitry to receive, from a device associated with a user and located remote from the server, a recommendation trigger message associated with a future trip, wherein the recommendation trigger message includes a destination of the future trip, an analyzer to determine a starting location of the device associated with the future trip, and determine, based on the starting location and the destination, at least one characteristic associated with the future trip, and a recommendation engine to identify, based on the at least one characteristic, a classification associated with the future trip, the classification generated based on at least one prior trip of the user, identify a mode of transportation associated with the classification, and cause the communication circuitry to transmit, to the device, an indication of the mode of transportation.

Example 31 may include the server of example 30, wherein the at least one characteristic includes the starting location and the destination, and wherein the at least one prior trip used for generation of the classification includes one or more prior trips from the starting location to the destination.

Example 32 may include the server of any of the examples 30 and 31, wherein the recommendation trigger message includes the current location of the device, wherein to determine the starting location, the analyzer is to identify the current location within the recommendation trigger message, and wherein the starting location is the current location.

Example 33 may include the server of any of the examples 30 and 31, wherein the analyzer is to further obtain weather information associated with the future trip, wherein the at least one characteristic includes the weather information.

Example 34 may include the server of any of the examples 30 and 31, wherein the recommendation trigger message further includes an arrival time at the destination, and wherein the at least one characteristic includes the arrival time.

Example 35 may include the server of any of the examples 30 and 31, wherein the analyzer is to further determine a distance between the starting location and the destination, and wherein the at least one characteristic includes the distance.

Example 36 may include the server of any of the examples 30 and 31, wherein the recommendation trigger message further includes an arrival time for the device at the destination, wherein the analyzer is to further determine a time difference between a current time and the arrival time, determine a travel time for the mode of transportation from the starting location to the destination, and determine that the travel time is greater than the time difference, and the recommendation engine is to further update the mode of transportation in response to the determination that the travel time is greater than the time difference, wherein the mode of transportation included in the indication of the mode of transportation is the updated mode of transportation.

Example 37 may include the server of any of the examples 30 and 31, wherein the analyzer is to further obtain public transportation information associated with the future trip, and determine convenience of a public transportation route from the starting location to the destination based on the public transportation information, wherein the at least one characteristic includes the convenience of the public transportation route.

Example 38 may include the server of example 37, wherein the convenience of the public transportation route includes a walking distance associated with the public transportation route, a wait time associated with the public transportation route, a number of transfers associated with the public transportation route, or a travel time associated with the public transportation route.

Example 39 may include the server of any of the examples 30 and 31, wherein the analyzer is to further identify the at least one prior trip within recorded data associated with the user stored in a database, determine one or more characteristics associated with the at least one prior trip, determine the mode of transportation associated with the at least one prior trip, generate the classification based on the one or more characteristics, and associate the mode of transportation with the classification.

Example 40 may include the server of example 39, wherein the one or more characteristics associated with the at least one prior trip include a starting location of the at least one prior trip and a destination of the at least prior trip.

Example 41 may include the server of example 39, wherein the one or more characteristics associated with the at least one prior trip include a route of the at least one prior trip, wherein the analyzer is to further obtain public transportation information, wherein the public transportation information includes a public transportation route, and compare the route of the at least one prior trip with the public transportation route, wherein the mode of transportation is to be determined based on the comparison.

Example 42 may include the server of example 39, wherein the analyzer is to further obtain weather information associated with the at least one prior trip, wherein the one or more characteristics associated with the at least one prior trip include the weather information.

Example 43 may include the server of example 39, wherein the one or more characteristics associated with the at least one prior trip include a trajectory of the device during the at least one prior trip, a velocity of the device during the at least one prior trip, presence of a connection to a global positioning system during the at least one prior trip, presence of a connection to car communication system during the at least one prior trip, presence of a connection to wireless fidelity (WIFI) during the at least one prior trip, usage of the device during the at least one prior trip, or an acceleration during the at least one prior trip.

Example 44 may include the server of example 39, wherein the database includes a graph database that stores the recorded data.

Example 45 may include one or more computer-readable media having instructions stored thereon, wherein the instructions, in response to execution by a server, cause the server to identify, by an analyzer of the server, a starting location associated with a future trip of a user and a destination associated with the future trip within a recommendation trigger message received from a device associated with the user and located remote from the server, determine, by the analyzer, at least one characteristic associated with the future trip based on the starting location and the destination, identify, by a recommendation engine of the server and based on the at least one characteristic, a classification associated with the future trip, the classification generated based on at least one prior trip of the user, identify, by the recommendation engine, a mode of transportation associated with the classification, and transmit, by the recommendation engine via communication circuitry of the server, an indication of the mode of transportation for the future trip to the device.

Example 46 may include the one or more computer-readable media of example 45, wherein the at least one characteristic includes the starting location and the destination, and wherein the at least one prior trip used for generation of the classification includes one or more prior trips from the starting location to the destination.

Example 47 may include the one or more computer-readable media of any of the examples 45 and 46, wherein the instructions, in response to execution by the server, further cause the server to obtain, by the analyzer via the communication circuitry, weather information associated with the future trip based on the starting location and the destination, wherein the at least one characteristic includes the weather information.

Example 48 may include the one or more computer-readable media of any of the examples 45 and 46, wherein the instructions, in response to execution by the server, further cause the server to identify, by the recommendation engine, an arrival time associated with the future trip within the recommendation trigger message, wherein the at least one characteristic includes the arrival time.

Example 49 may include the one or more computer-readable media of any of the examples 45 and 46, wherein the instructions, in response to execution by the server, further cause the server to determine, by the analyzer, a time difference between a current time and the arrival time, determine, by the analyzer, a travel time for the mode of transportation from the starting location to the destination, determine, by the analyzer, the travel time is greater than the time difference, and update, by the recommendation engine, the mode of transportation in response to the determination that the travel time is greater than the time difference, wherein the mode of transportation included in the indication of the mode of transportation is updated mode of transportation.

Example 50 may include the one or more computer-readable media of any of the examples 45 and 46, wherein the instructions, in response to execution by the server, further cause the server to determine, by the analyzer, a distance between the starting location and the destination, wherein the at least one characteristic includes the distance.

Example 51 may include the one or more computer-readable media of any of the examples 45 and 46, wherein the instructions, in response to execution by the server, further cause the server to obtain, by the analyzer via the communication circuitry, public transportation information associated with the future trip, and determine, by the analyzer, convenience of a public transportation route from the starting location to the destination based on the public transportation information, wherein the at least one characteristic includes the convenience of the public transportation route.

Example 52 may include the one or more computer-readable media of example 51, wherein the convenience of the public transportation route includes a walking distance associated with the public transportation route, a wait time associated with the public transportation route, a number of transfers associated with the public transportation route, or a travel time associated with the public transportation route.

Example 53 may include the one or more computer-readable media of any of the examples 45 and 46, wherein the instructions, in response to execution by the server, further cause the server to identify, by the analyzer, the at least one prior trip within recorded data associated with the user stored in a database, determine, by the analyzer, one or more characteristics associated with the at least one prior trip, determine, by the analyzer, the mode of transportation associated with the at least one prior trip, generate, by the analyzer, the classification based on the one or more characteristics, and associate, by the analyzer, the mode of transportation with the classification.

Example 54 may include the one or more computer-readable media of example 53, wherein the one or more characteristics associated with the at least one prior trip include a starting location of the at least one prior trip and a destination of the at least prior trip.

Example 55 may include the one or more computer-readable media of example 53, wherein the one or more characteristics associated with the at least one prior trip include a route of the at least one prior trip, and wherein the instructions, in response to execution by the server, further cause the server to obtain, by the analyzer via the communication circuitry, public transportation information, wherein the public transportation information includes a public transportation route, and compare, by the analyzer, the route of the at least one prior trip with the public transportation route, wherein the mode of transportation is to be determined based on the comparison.

Example 56 may include the one or more computer-readable media of example 53, wherein the instructions, in response to execution by the server, further cause the server to obtain, by the analyzer via the communication circuitry, weather information associated with the at least one prior trip, wherein the one or more characteristics associated with the at least one prior trip include the weather information.

Example 57 may include the one or more computer-readable media of example 53, wherein the one or more characteristics associated with the at least one prior trip include a trajectory of the device during the at least one prior trip, a velocity of the device during the at least one prior trip, presence of a connection to a global positioning system during the at least one prior trip, presence of a connection to car communication system during the at least one prior trip, presence of a connection to wireless fidelity (WIFI) during the at least one prior trip, usage of the device during the at least one prior trip, or an acceleration during the at least one prior trip.

Example 58 may include the one or more computer-readable media of example 53, wherein the database includes a graph database with one or more prior trips stored within a graphical structure.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A device, comprising:
communication circuitry to communicate with a server;
a user interface to interact with a user of the device;
an analyzer to identify a future trip to be travelled by the user, and identify a destination associated with the future trip; and
a recommendation engine to:
transmit, to the server via the communication circuitry, a recommendation trigger message that includes an indication of the destination;
receive, from the server via the communication circuitry, an indication of a mode of transportation to the destination, the indication of the mode of transportation based on prior trip information of the user; and
cause a notification for use of the mode of transportation to the destination to be indicated by the user interface.

2. The device of claim 1, wherein, to identify the future trip, the analyzer is to:
identify an appointment in a calendar application; and
determine that the future trip is to be travelled by the user to attend the appointment.

3. The device of claim 1, wherein the analyzer is to further:
identify, on the device, an application for a service that provides the mode of transportation, wherein the notification for use of the mode of transportation includes an indication of the application.

4. The device of claim 1, wherein the recommendation engine is to further:
determine that the mode of transportation is a user-operated mode of transportation; and
provide directions to the destination based on the mode of transportation being the user-operated mode of transportation.

5. The device of claim 4, wherein to provide the directions, the recommendation engine is to further:
identify, on the device, a map application; and
obtain, from the map application, the directions based on the destination.

6. The device of claim 1, wherein the recommendation engine is to further determine a current location of the device, wherein the recommendation trigger message further includes an indication of the current location.

7. The device of claim 1, wherein the recommendation engine is to further:
determine an arrival time for the device at the destination; and
determine, based on the mode of transportation, an estimated travel time to the destination, wherein the notification for use of the mode of transportation is displayed at a time based on the arrival time and the estimated travel time.

8. The device of claim 1, further comprising:
a memory device coupled to the analyzer and the recommendation engine, wherein the recommendation engine is to further:
record user state information to the memory device; and
transmit, to the server via the communication circuitry, at least a portion of the user state information from the memory device, the at least the portion of the user state information used by the server for generation of one or more classifications associated with one or more modes of transportation.

9. The device of claim 1, wherein the device is a user equipment.

10. A server, comprising:
communication circuitry to:
receive, from a device associated with a user and located remote from the server, a recommendation trigger message associated with a future trip, wherein the recommendation trigger message includes a destination of the future trip;
an analyzer to:
determine a starting location of the device associated with the future trip; and
determine, based on the starting location and the destination, at least one characteristic associated with the future trip; and
a recommendation engine to:
identify, based on the at least one characteristic, a classification associated with the future trip, the classification generated based on at least one prior trip of the user;
identify a mode of transportation associated with the classification; and
cause the communication circuitry to transmit, to the device, an indication of the mode of transportation.

11. The server of claim 10, wherein the at least one characteristic includes the starting location and the destination, and wherein the at least one prior trip used for generation of the classification includes one or more prior trips from the starting location to the destination.

12. The server of claim 10, wherein the analyzer is to further obtain weather information associated with the future trip, wherein the at least one characteristic includes the weather information.

13. The server of claim 10, wherein the recommendation trigger message further includes an arrival time at the destination, and wherein the at least one characteristic includes the arrival time.

14. The server of claim 10, wherein the analyzer is to further determine a distance between the starting location and the destination, and wherein the at least one characteristic includes the distance.

15. The server of claim 10, wherein the recommendation trigger message further includes an arrival time for the device at the destination, wherein:
the analyzer is to further:
determine a time difference between a current time and the arrival time;
determine a travel time for the mode of transportation from the starting location to the destination; and
determine that the travel time is greater than the time difference; and
the recommendation engine is to further:
update the mode of transportation in response to the determination that the travel time is greater than the time difference, wherein the mode of transportation included in the indication of the mode of transportation is the updated mode of transportation.

16. The server of claim 10, wherein the analyzer is to further:
obtain public transportation information associated with the future trip; and
determine convenience of a public transportation route from the starting location to the destination based on the public transportation information, wherein the at least one characteristic includes the convenience of the public transportation route.

17. The server of claim 16, wherein the convenience of the public transportation route includes a walking distance associated with the public transportation route, a wait time associated with the public transportation route, a number of transfers associated with the public transportation route, or a travel time associated with the public transportation route.

18. One or more computer-readable media having instructions stored thereon, wherein the instructions, in response to execution by a travel device, cause the travel device to:
transmit, to a server, a recommendation trigger message that includes an indication of a destination for a user of the travel device;
receive, from the server, an indication of a mode of transportation to the destination, the indication of the mode of transportation based on prior trip information of the user; and
initiate, via a user interface of the travel device, a notification for use of the mode of transportation to the destination.

19. The one or more computer-readable media of claim 18, wherein the instructions, in response to execution by the travel device, further cause the device to:
identify, on the travel device, an application for a service that provides the mode of transportation, wherein the notification for use of the mode of transportation includes an indication of the application.

20. The one or more computer-readable media of claim 19, wherein the indication of the application includes a link to the application.

21. The one or more computer-readable media of claim 18, wherein to display the notification for use of the mode of transportation includes to:
determine an arrival time for intended arrival of the travel device at the destination; and
determine, based on the mode of transportation, an estimated travel time from a current location of the travel device to the destination, wherein the notification for use of the mode of transportation is displayed at a time based on the arrival time and the estimated travel time.

22. One or more computer-readable media having instructions stored thereon, wherein the instructions, in response to execution by a server, cause the server to:
identify, by an analyzer of the server, a starting location associated with a future trip of a user and a destination associated with the future trip within a recommendation trigger message received from a device associated with the user and located remote from the server;
determine, by the analyzer, at least one characteristic associated with the future trip based on the starting location and the destination;
identify, by a recommendation engine of the server and based on the at least one characteristic, a classification associated with the future trip, the classification generated based on at least one prior trip of the user;
identify, by the recommendation engine, a mode of transportation associated with the classification; and
transmit, by the recommendation engine via communication circuitry of the server, an indication of the mode of transportation for the future trip to the device.

23. The one or more computer-readable media of claim 22, wherein the instructions, in response to execution by the server, further cause the server to:
identify, by the recommendation engine, an arrival time associated with the future trip within the recommendation trigger message, wherein the at least one characteristic includes the arrival time.

24. The one or more computer-readable media of claim 22, wherein the instructions, in response to execution by the server, further cause the server to:
determine, by the analyzer, a time difference between a current time and the arrival time;
determine, by the analyzer, a travel time for the mode of transportation from the starting location to the destination;
determine, by the analyzer, the travel time is greater than the time difference; and
update, by the recommendation engine, the mode of transportation in response to the determination that the travel time is greater than the time difference, wherein the mode of transportation included in the indication of the mode of transportation is updated mode of transportation.

25. The one or more computer-readable media of claim 22, wherein the instructions, in response to execution by the server, further cause the server to:
obtain, by the analyzer via the communication circuitry, public transportation information associated with the future trip; and
determine, by the analyzer, convenience of a public transportation route from the starting location to the destination based on the public transportation information, wherein the at least one characteristic includes the convenience of the public transportation route.
